(19) United States
(12) Patent Application Publication
(10) Pub. No.: US 2010/0167171 A1
(43) Pub. Date: Jul. 1, 2010

(54) Fuel Cell Component, Porous Body for Fuel Cell and Method of Manufacturing Fuel Cell Component

(76) Inventor: Tomoharu Sasaoka, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/086,617

(22) PCT Filed: Jan. 16, 2007
(86) PCT No.: PCT/IB2007/000109

§ 371 Date: Jun. 16, 2008

(30) Foreign Application Priority Data
Jan. 16, 2006 (JP) 2006-007681

(51) Int. Cl. H01M 2/08; B29C 65/70

(52) U.S. Cl. 429/508; 156/77

(57) ABSTRACT

A porous body (28, 29) for a fuel cell (1000), a fuel cell component including the porous body and a method of manufacturing the fuel cell component is provided. The porosity in at least a portion (15) in the vicinity of the periphery of the porous body (28, 29) is lower than the porosity in an interior portion of the porous body. When a seal member (30) is arranged on the periphery of the porous body (28, 29) to be integrated with the porous body, the interior portion of the porous body (28, 29), is prevented from being impregnated with the seal member.

### BACKGROUND OF THE INVENTION

1. Field of the Invention

This invention generally relates to a fuel cell component, a porous body for a fuel cell, and a method of manufacturing the fuel cell component, and in particular, to a fuel cell component, a porous body for the fuel cell and a method of manufacturing the fuel cell component, in which a sealing structure is provided to improve airtightness.

2. Description of the Related Art

In recent years, a fuel cell is known that generates electricity by electrochemical reaction between hydrogen and oxygen, as an energy source. The fuel cell is composed of, for example, membrane electrode assemblies and separators serving as collectors, that are alternately laminated on each other and are pressed from both ends thereof. The membrane electrode assembly is formed by laminating electrocatalyst layers on a solid polymer electrolyte membrane and arranging multiple porous layers having different porosities outside the electrocatalyst layer. Reaction gas, such as fuel gas, oxidization gas and the like, supplied from outside flows through manifolds formed by laminating the separators in the fuel cell, and then is supplied to the membrane electrode assemblies via the porous layers. In the fuel cell having manifolds, seal members are provided in the laminating process to suppress the leakage of the reaction gas.

The fuel cell having the seal member is formed by, for example, pouring (injecting) thermosetting resin into the gap between the outer peripheral portion of the membrane electrode assembly and the inner peripheral portion of the seal member, thereby integrating the membrane electrode assembly and the seal member (Japanese Patent Application Publication Nos. 2005-183210 and 2002-42836).

In the conventional technology, however, when the multiple porous layers having different porosities from each other are integrated with the seal member using the thermosetting resin, the porous layer having a higher porosity is more impregnated with the thermosetting resin, as compared with the porous layer having a lower porosity. Accordingly, the flow of the reaction gas is blocked and the generating efficiency decreases.

### SUMMARY OF THE INVENTION

The present invention provides a fuel cell component, a porous body for a fuel cell and a method of manufacturing the fuel cell component that maintains airtightness and improves the flow efficiency of the fuel cell.

In one aspect of the present invention, a method of manufacturing a fuel cell component provided with a first porous body having a first porosity and a second porous body having a second porosity that is higher than the first porosity. The first porous body including conductive material is laminated on a membrane electrode assembly. A porosity adjustment process is performed that forms at least a portion in the vicinity of the periphery of the second porous body with the porosity lower than the second porosity. The second porous body is laminated on the first porous body laminated on the membrane electrode assembly. A seal member including at least one of a thermosetting resin and a thermoplastic resin is injected on the periphery of the membrane electrode assembly on which the first porous body and the second porous body are laminated, to integrate the membrane electrode assembly, the second porous body and the seal member by injection molding.

According to this aspect of the present invention, because the porosity in at least a portion in the vicinity of the periphery of the second porous body is lower than the second porosity, the impregnation of the seal member into the area on the inner side of the vicinity of the periphery of the second porous body with the lower porosity, is suppressed. Accordingly, the reaction gas flows well in the interior area, which is on the inner side of the vicinity of the periphery; and the generating efficiency in the membrane electrode assembly is improved.

The porosity adjustment process may impregnate the at least the portion in the vicinity of the periphery of the second porous body with a predetermined material.

Accordingly, the porosity in the portion in the vicinity of the periphery of the second porous body can be reduced in a simple manner.

The second porous body may be a porous channel in which the gas used for electric generation in the fuel cell flows in a predetermined direction, and the first porous body may be a gas diffusion layer that diffuses the gas.

Accordingly, when the porous channel is integrally formed with the seal member by injection molding, the impregnation of the seal member into the area of the porous channel necessary for the gas to flow is suppressed.

The first porous member may be laminated on the membrane electrode assembly by joining the first porous member on both sides of the membrane electrode assembly.

Accordingly, because the membrane electrode assembly and the first porous body are joined, the displacement between the membrane electrode assembly and the first porous body is suppressed and the occurrence of boundary (gap) between the membrane electrode assembly and the first porous body is suppressed.

In another aspect of the present invention, a fuel cell component is provided. The fuel cell component includes a membrane electrode assembly, a gas diffusion layer having a first porosity, laminated on the membrane electrode assembly, and a porous channel laminated on the gas diffusion layer. The porous channel has an interior portion with a second porosity that is higher than the first porosity and at least a portion in the vicinity of the periphery of the porous channel with the porosity lower than the second porosity. The fuel cell component further includes a seal member integrated with the gas diffusion layer and the porous channel by injection molding.

According to this aspect of the present invention, because the porosity in at least a portion in the vicinity of the periphery of the porous channel is lower than the second porosity, the impregnation of the seal member into the area on the inner side of the vicinity of the periphery of the porous channel is suppressed at the time of injection molding. Therefore, by making the fuel cell using the fuel cell component, the reaction gas flows well in the interior area, which is on the inner side of the vicinity of the periphery, and the generating efficiency in the fuel cell is improved.

In further aspect of the present invention, a porous body for a fuel cell is provided. The porous body is configured to be integrated with a seal member arranged on the periphery of the porous body: The porosity in the portion in the vicinity of the periphery of the porous body is lower than the porosity in the interior portion of the porous body. According to this aspect of the present invention, the flow of the reaction gas is less blocked.

In another aspect of the present invention, a method of manufacturing a fuel cell component is provided. In the method, a porous body is formed in which the porosity in at least a portion in the vicinity of the periphery of the porous body is lower than the porosity in the interior portion of the porous body. A seal member is arranged on the periphery of the porous body and integrated with the porous body.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a perspective view illustrating a schematic construction of a fuel cell according to an embodiment of the present invention;

FIG. 2 is a cross section illustrating a fuel cell cell according to the embodiment;

FIG. 3 is a plan view illustrating an intermediate member according to the embodiment;

FIG. 4 is a flowchart illustrating an example of a manufacturing process of the intermediate member;

FIG. 5 is schematic view illustrating an impregnation process of the porous channel according to the embodiment;

FIG. 6 is a plan view illustrating an impregnation device according to the embodiment;

FIG. 7 is a cross section illustrating a porous channel according to the embodiment;

FIG. 8 is a schematic view illustrating injection molding according to the embodiment;

FIG. 9 is a schematic view illustrating the injection molding according to the embodiment;

FIG. 10 is an enlarged schematic view illustrating the injection molding according to the embodiment; and

FIG. 11 is a schematic view illustrating the injection molding according to the embodiment.

### DETAILED DESCRIPTION OF THE PREFERRED EMBODIMENTS

An embodiment of the present invention is described in detail below, with references made to the drawings.

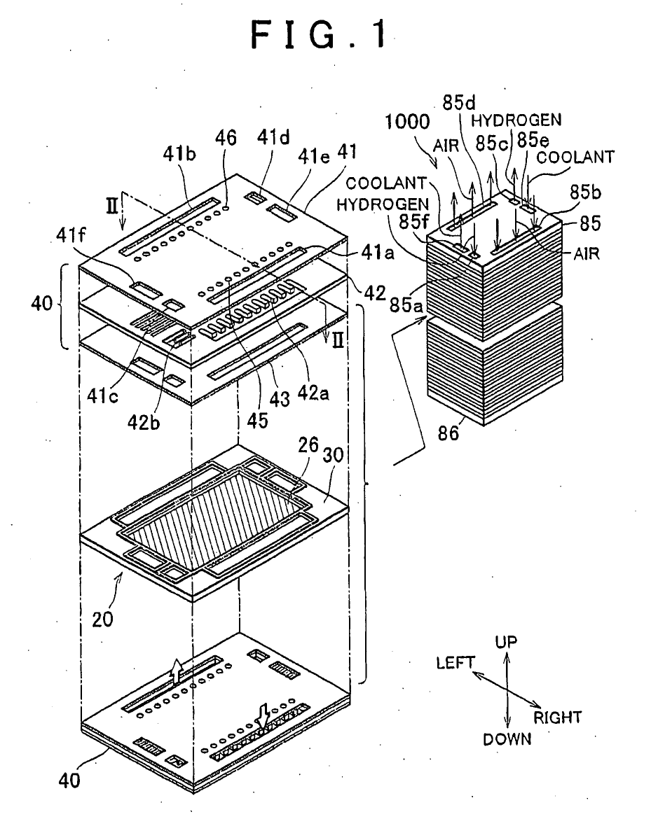

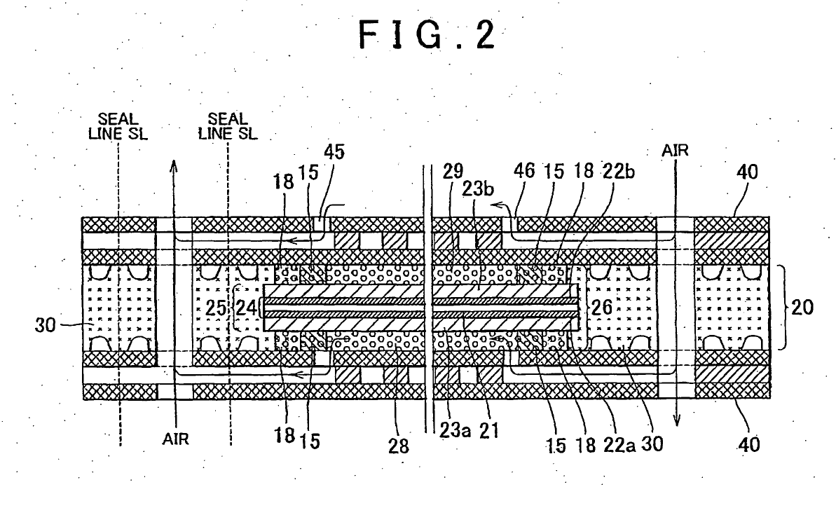

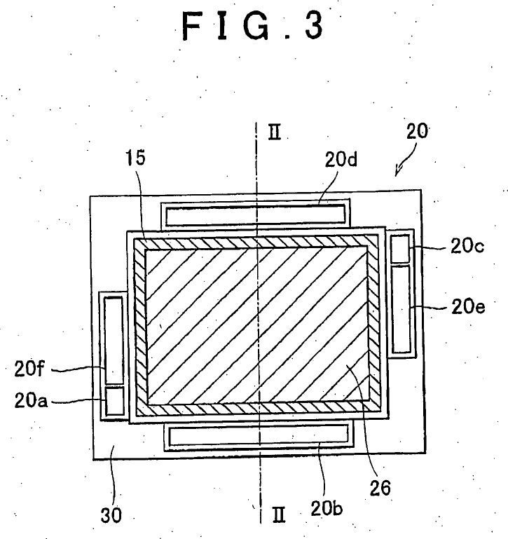

The construction of the fuel cell 1000 according to an embodiment of the present invention is described below with reference to FIGS. 1 to 3. FIG. 1 is a view illustrating a schematic construction of the fuel cell 1000 according to the embodiment. FIG. 2 is a cross section illustrating a fuel cell cell taken on line II-II of FIG. 1. FIG. 3 is a plan view illustrating an intermediate member 20 according to the embodiment. The fuel cell- 1000 according to the embodiment is a solid polymer fuel cell to which hydrogen gas and air are supplied and that generates electricity by electrochemical reaction between hydrogen and oxygen.

As shown in FIG. 1, the fuel cell 1000 includes intermediate members 20 that have electrolyte membranes, and separators 40 serving as partitions that collect electricity generated by electrochemical reaction. The separators 40 and the intermediate members 20 are alternately laminated on each other, and are sandwiched from the both ends by end plates 85 and 86.

The end plate 85 has a through hole 85a that supplies anode gas, a through hole 85b that supplies cathode gas, a through hole 85c that discharges anode off-gas, a through hole 85d that discharges cathode off-gas, a through hole 85e that supplies coolant, and a through hole 85f that discharges the coolant. The anode gas is supplied into the fuel cell 1000 from an unshown hydrogen tank through the through hole 85a. The cathode gas is compressed by an unshown compressor and is supplied into the fuel cell 1000 through the through hole 85b. The coolant is cooled by an unshown radiator and supplied to the fuel cell 1000 through the through hole 85e.

As shown in FIG. 2, the intermediate member 20 includes a membrane electrode assembly (MEA) 24, gas diffusion layers 23a, 23b, porous channels 28, 29, and a seal gasket 30. The gas diffusion layers 23a, 23b are arranged on both sides of the MEA 24. The portion composed of the MEA 24, gas diffusion layer 23a and the gas diffusion layer 23b is called MEGA 25. The MEA 24 can be regarded as the “membrane electrode assembly” of the present invention. The porous channels 28, 29 are provided between the MEGA 25 and the respective separators 40. The periphery of the MEGA 25 and porous channels 28, 29 is surrounded by the seal gasket 30 to integrate the MEGA 25, the porous channel 28, 29 and the seal gasket 30, and thus, the intermediate member 20 is formed.

The MEA 24 has a cathode electrocatalyst layer 22a and an anode electrocatalyst layer 22b on the surfaces of the electrolyte membrane 21. The electrolyte membrane 21 is a solid polymer thin membrane that has proton conductivity and shows a good electric conductivity in a wet condition. The electrolyte membrane 21 has a rectangular shape smaller than the profile of the separator 40. The electrolyte membrane 21 is made, of Nafion®, for example. The cathode electrocatalyst layer 22a and the anode electrocatalyst layer 22b formed on the surfaces of the electrolyte membrane 21 support (carry) a catalyst that enhances the electrochemical reaction, for example,. platinum.

The gas diffusion layers 23a, 23b are porous bodies with about twenty percent (20%) porosity, made of, for example, carbon cloth or carbon paper. The gas diffusion layers 23a, 23b and the MEA 24 are integrated by joining to form the MEGA 25. The gas diffusion layer 23a and the gas diffusion layer 23b are respectively located at the cathode side and the anode side of the MEA 24. The gas diffusion layer 23a diffuses the cathode gas in the thickness direction and supplies the cathode gas to the entire surface of the cathode electrocatalyst layer 22a. The gas diffusion layer 23b diffuses the anode gas in the thickness direction and supplies the anode gas to the entire surface of the anode electrocatalyst layer 22b.

The porous channels 28, 29 are made of a sintered foam metal, such as a stainless steel, titanium, titanium alloy, and so on. The porous channels 28, 29 have a generally rectangular shape that is smaller than but is almost as large as the MEGA 25. The porosity of the porous channels 28, 29 is higher than the porosity of the gas diffusion layers 23a, 23b included in The MEGA 25, and is approximately seventy to eighty percent (70-80%). The porous channels 28, 29 function as channels that supply the reaction gas to the MEGA 25.

For example, the porous channel 28 is provided between the cathode side of the MEGA 25 (cathode side of the MEA 24) and the separator 40. As shown in FIGS. 1 and 2, the porous channel 28 directs the air flowing from top to bottom of the fuel cell to the cathode side of the MEGA 25 via the separator 40.

On the other hand, the porous channel 29 is provided between the anode side of the MEGA 25 (anode side of the MEA 24) and the separator 40. As shown in FIG. 1, the porous channel 29 directs the hydrogen gas flowing from top to bottom of the fuel cell to the anode side of the MEGA 25 via the separator 40.

In other words, because the main object of the porous channels 28, 29 is to have the reaction gas flow in the predetermined direction, the porous channels 28, 29 have a relatively high porosity to suppress the pressure loss of the reaction gas flow and improve the drainage. On the other hand, because the main object of the gas diffusion layers 23a, 23b is to diffuse the gas in the thickness direction, the gas diffusion layers 23a, 23b have a relatively low porosity (lower than the porosity of the porous channels 28, 29).

The reaction gas flowing in the porous channels 28, 29 is supplied to the MEGA 25 while flowing, and is diffused to the cathode electrocatalyst layer 22a and anode electrocatalyst layer 22b through the gas diffusion layers 23a, 23b of the MEGA 25, to be used in the electrochemical reaction. Because the electrochemical reaction is an exothermic reaction, the coolant is supplied inside the fuel cell 1000 to operate the fuel cell 1000 within the predetermined temperature range.

In this embodiment, the portion composed of the MEGA 25 and the porous channels 28, 29 arranged on both surfaces of the MEGA 25 is called electrode member 26. The seal gasket 30 that encloses the outer periphery of the electrode member 26 is made of elastic rubber-made insulating resin material, such as a silicone rubber, butyl rubber, fluoro-rubber and the like, and is formed on the outer periphery of the electrode member 26 by injection molding, thereby integrating the seal gasket 30 and the electrode member 26. In this embodiment, the seal gasket 30 is made of fluoro-rubber.

The predetermined area 15 near the outer periphery of porous channels 28, 29 (hatched area in FIGS. 2 and 3) is impregnated with silicone resin. Hereinafter, in the embodiment, the area 15 that is impregnated with resin is called a resin-impregnated area 15, and the area 18 that is located on the outer side of the resin-impregnated area 15 is called a seal member impregnated area 18.

When the seal gasket 30 is injection molded, the pores in the gas diffusion layers 23a, 23b and porous channels 28, 29 are impregnated with the fluoro-rubber, thereby integrating the seal gasket 30 with the MEGA 25 and the porous channels 28, 29. In this embodiment, the pores in the resin-impregnated area 15 of the porous channel 28, 29 have been impregnated with a silicone resin. In other words, because the pores are clogged with silicone resin, the impregnation of the fluoro-rubber into the area on the inner side of the resin-impregnated area 15 is prevented or suppressed.

The seal gasket 30 is formed as a part of the intermediate member 20, and has a substantially rectangular shape, similar to that of the separator 40. As shown in FIG. 3, the openings 20a to 20f for manifolds are formed along the four sides of the intermediate member 20. To distinguish the openings 20a to 20f for manifolds provided in the seal gasket 30 from the openings for the manifolds provided in the separator 40, the openings 20a to 20f in the seal gasket 30 are called continuous holes 20a to 20f in this embodiment. Each of the continuous holes 20a to 20f forms a part of manifolds through which the fluid (hydrogen, air or coolant) in the fuel cell 1000 flows. The continuous hole 20a forms a part of an anode gas manifold, and the continuous hole 20b forms a part of a cathode gas manifold. The continuous hole 20c forms a part of an anode off-gas manifold, and the continuous hole 20d forms a part of a cathode off-gas manifold. The continuous hole 20e forms a part of a coolant supply manifold, and the continuous hole 20f forms a part of a coolant discharge manifold.

The seal gasket 30 includes protruding portions that protrude in the thickness direction of the seal gasket 30 and enclose the continuous holes. The protruding portions are interposed between the separators 40, receive the fastening force in the laminating direction, and are collapsed and deformed in the laminating direction. As a result, as shown in FIG. 2, the protruding portions form seal lines SL that suppress the leakage of the fluid (hydrogen, air or coolant) from the manifolds.

Next, the separator 40 that collects the electricity generated by the electrochemical reaction is described. The separator 40 is a three-layered stacked separator, formed by laminating three thin metal plates. More specifically, the separator 40 includes a cathode plate 41 contacting the porous channel 28, in which air flows, an anode plate 43 contacting the porous channel 29, in which hydrogen gas flows, and an intermediate plate 42 that is interposed between the cathode and anode plates and in which the coolant mainly flows.

Each of the three plates has a flat surface without any recess or protrusion to form channels in the thickness direction thereof (i.e., the surface contacting the porous channel 28 or 29 is flat). Each plate is made of conductive metallic material, such as a stainless steel, titanium, titanium alloy, or the like.

The three plates have through holes that form the above described various manifolds. More specifically, as shown in FIG. 1, an elongated through hole 41a for supplying air and an elongated through hole 41b for discharging air are provided along the long side of the substantially rectangular separator 40. A through hole 41c for supplying hydrogen and the through hole 41d for discharging hydrogen are provided at the short side of the rectangular separator 40. Further, a though hole 41e for supplying coolant and a through hole 41f for discharging coolant are provided at the short side of rectangular separator 40.

In addition to the through holes for the manifolds, the cathode plate. 41 further includes multiple openings 45 and 46 that are inlet and outlet of air from and to the porous channel 28. Similarly, in addition to the through holes for the manifolds, the anode plate 43 includes multiple openings (not shown) that are inlet and outlet of hydrogen gas from and to the porous channel 29.

In the multiple through holes for the manifolds provided in the intermediate plate 42, the through holes 42a for the manifold in which air flows are formed to be communicated with the openings 45 in the cathode plate 41. Further, through holes 42b for the manifold in which hydrogen gas flows are formed to be communicated with the openings (not shown) in the anode plate 43.

Further, plural notches are provided in the intermediate plate 42 along the long side of the substantially rectangular shape, and the ends of the notches are communicated with the through hole for the manifold in which the coolant flows.

By laminating and joining the three plates having the above-described structure, channels for various fluids are formed in the separator 40.

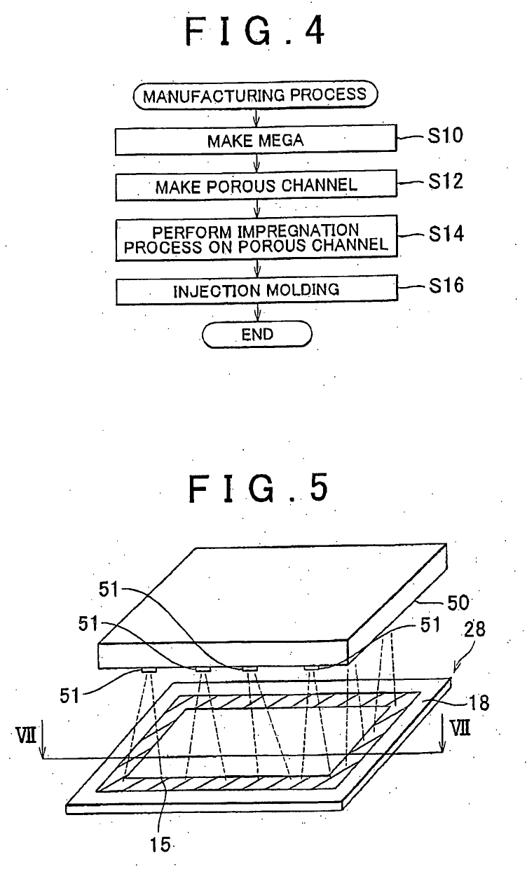

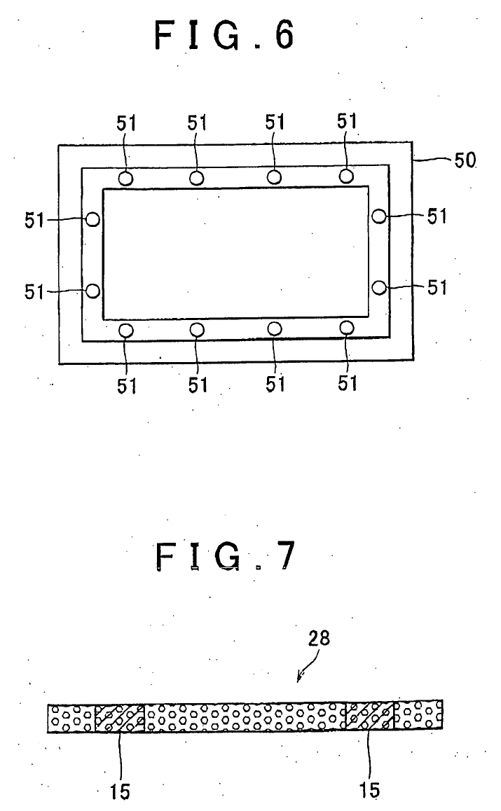

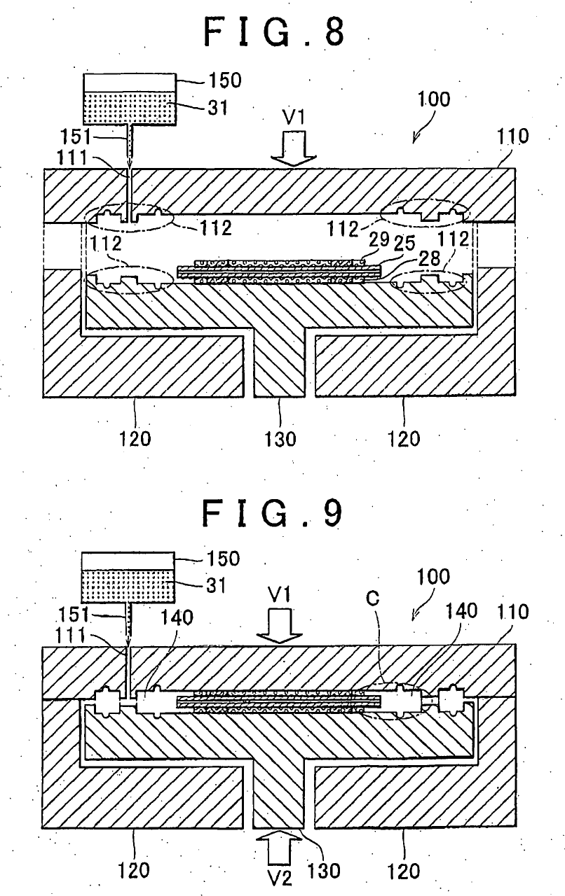

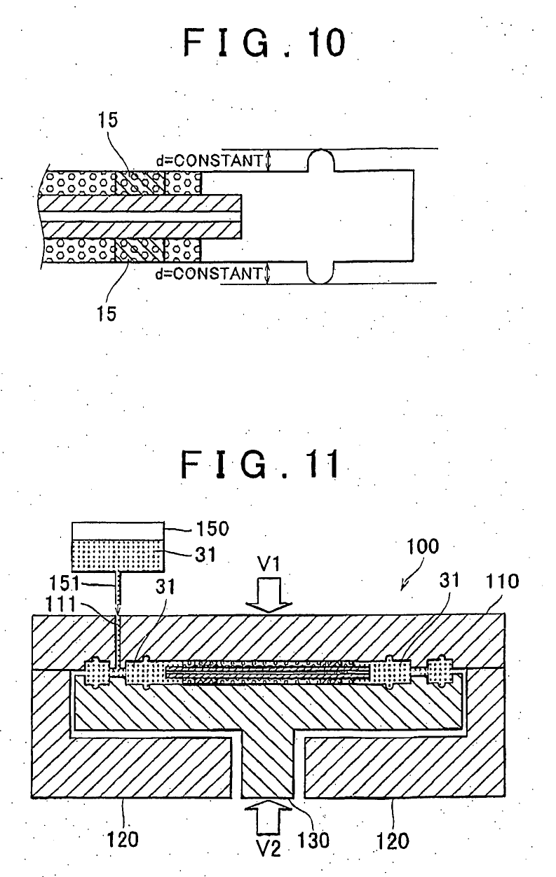

The process of manufacturing the intermediate member 20 is described with reference to FIGS. 4 to 11. FIG. 4 is a flowchart illustrating an example of a process of manufacturing the intermediate member 20 according to the embodiment of the present invention. FIG. 5 is a schematic view illustrating the impregnation process of the porous channel according to the embodiment. FIG. 6 is a plan view illustrating an impregnation device according to the embodiment. FIG. 7 is a cross section illustrating the porous channel taken on line VII-VII of FIG. 5. FIGS. 8, 9 and 11 are schematic views illustrating the injection molding according to the embodiment. FIG. 10 is an enlarged schematic view illustrating the portion C circled by the dashed line in FIG. 9.

First, the MEGA 25 is made (step S10). More specifically, for example, the platinum is supported (carried) on the both sides of the electrolyte membrane to form the cathode electrocatalyst layer 22a and the anode electrocatalyst layer 22b, thereby forming the MEA 24. Then, the gas diffusion layer 23a is joined on the cathode side of the MEA 24, and the gas diffusion layer 23b is joined on the anode side of the MEA 24 to make the MEGA 25.

Next, the porous channels 28, 29 are made (step S12). More specifically, for example, foaming agent is added into metal powder, and a binder resin aqueous solution is further mixed therewith to form slurry. The slurry is shaped in a predetermined shape, and is heated at the temperature near the foaming temperature of the foaming agent to make the foaming agent foam. The shaped slurry is then dried and sintered at the temperature defined depending upon the material of the metal powder. Thus, the porous channels 28, 29 are formed.

The resin-impregnated area 15 in the formed porous channels 28, 29 is impregnated with silicone resin (step S14). The impregnation process is described in detail with reference to FIGS. 5 to 7. Because the porous channel 29 has the structure similar to that of the porous channel 28, the impregnation process is described by taking the porous channel 28 as an example, hereinafter.

In the impregnation process according to the embodiment, the impregnation device 50 applies silicone resin to the resin-impregnated area 15 of the porous channel 28, as shown by the broken lines in FIG. 5. The impregnation device 50 has twelve splay nozzles 51, as shown in FIG. 6. The splay nozzles 51 are injection outlets that inject silicone resin.

The impregnation device 50 injects the silicone resin through the splay nozzles 51, and impregnates and soaks the resin impregnated area 15 of the porous channel 28 with the silicone resin, as shown by hatching in FIG. 7. The silicone resin used for the impregnation may be, for example, alkyd resin or epoxy resin. Alternative to the impregnation device. 50 according to the embodiment, the porous channel 28 may be impregnated with silicone resin by using a brush or roller, or by dipping that impregnates the resin-impregnated area 15 of the porous channel 28 with the predetermined amount of resin evenly. Further, the porous channel 28 may be impregnated with resin by electrodeposition.

The porous channel 28 on which the impregnation process has been performed in the step S14 is laminated on the cathode side of the MEGA 25, and the porous channel 29 on which the impregnation process has been performed in the step S14 is laminated on the anode side of the MEGA 25. Then, the MEGA 25 with the porous channels 28, 29 is set in the molding die to mold the intermediate member 20 by injection molding (step S16). The injection molding is described hereinafter with reference to FIGS. 8 to 11.

As shown in FIG. 8, the mold 100 has an upper die 110, a lower die 120 and a lower core die 130. The upper die 110 includes a gate 111. The gate 111 is an inlet to inject resin material into the closed mold 100. The upper die 100 and the lower core die 130 have recesses and protrusions 112 that form the seal line SL.

The injection device 150 is a device that injects resin material 31 into the mold 100. The injection device 150 has a nozzle 151 to inject the resin material 31. The injection device 150 stores melt liquid resin material 31 at a constant temperature. In this embodiment, because the resin material 31 is fluoro-rubber, the resin material 31 is also called fluoro-rubber 31.

The lower die 120 is statically fixed and the upper die 110 moves toward the lower die 120 to close the upper die 110 and the lower die 120. The pressure V1 applied to close the upper die 110 and the lower die 120 can be determined appropriately.

The lower core die 130 is pressed toward the upper die 110, independent of the closing of the upper die 110 and the lower die 120, to close the lower core die 130 and the upper die 110. When the upper die 110 and the lower die 120, and the upper die 110 and the lower core die 130 are respectively closed, as shown in FIG. 9, cavity 140 including the recesses and protrusions 112 formed on the upper die 110 and the lower core die 130 is formed between the upper die 110 and the lower core die 130.

The pressure V2 applied to the lower core die 130 may be set the pressure same as the fastening pressure applied when the fuel cell stacks are fastened. By doing so, when the injection molding is performed, the height d between the MEGA 25 and the upper die 110 is maintained constant, as shown in FIG. 10, and the load applied to the electrode member 26 is maintained constant.:

After the mold 100 is closed, the injection device 150 injects the liquid fluoro-rubber 31 into the cavity 140 through the gate 111. As shown in FIG. 11, the cavity 140 is filled with the injected fluoro-rubber 31.

Because the fluoro-rubber 31 is thermosetting material, the liquid fluoro-rubber 31 is hardened by heat treatment. The hardened fluoro-rubber 31 may have the hardness of 30 to 70 (degrees) in JISA of Japanese Industrial Standards (JIS). Further, the breaking elongation of the hardened fluoro-rubber may be equal to or higher than 300%.

After the fluoro-rubber 31 in the cavity 140 is hardened enough, the molding die 100 is opened. Thus, the intermediate member 20 is formed in which the electrode member 26 is integrally formed with the seal gasket 30 that is made of fluoro-rubber 31 and provided on the periphery of the electrode member 26.

According to the method of manufacturing the intermediate member of the embodiment, by impregnating a portion in the vicinity of the periphery of the porous channel with resin, the pores in the impregnated area are clogged. Accordingly, the impregnation of the fluoro-rubber into the area on the inner side of the resin-impregnated area is prevented, and the reduction of the generating efficiency is suppressed.

Further, according to the manufacturing method of the embodiment, the MEGA, the porous channel and the seal gasket are integrally molded. Therefore, the occurrence of the gap between the porous channel and the seal gasket is suppressed or prevented, and the fuel gas is efficiently supplied to the MEA.

In the above-described embodiment, the vicinity of the periphery of the porous channel is impregnated with resin to reduce the porosity therein. However, the method to adjust the porosity is not limited thereto. For example, when the porous channel is formed, the amount of foaming agent included in the slurry may be changed. The porous channel may be formed by using the slurry including less foaming agent in the area in the vicinity of the periphery where'the lower porosity is expected.

Further, to reduce the porosity in the vicinity of the periphery of the porous body, the vicinity of the periphery of the porous body may be shaped thicker than the other area, and then the thicker portion in the vicinity of the periphery may be pressed to collapse the pores in the vicinity of the periphery.

In the above-described embodiment, the electrode member 26 includes the gas diffusion layers 23a, 23b; however, the gas diffusion layers 23a, 23b may not be necessarily included.

While some embodiments of the invention have been illustrated above, it is to be understood that the invention is not limited to details of the illustrated embodiments, but may be embodied with various changes, modifications or improvements, which may occur to those skilled in the art, without departing from the spirit and scope of the invention.

1. A method of manufacturing a fuel cell component provided with a first porous body having a first porosity and a second porous body having a second porosity that is higher than the first porosity, the method comprising:
laminating the first porous body including conductive material on a membrane electrode assembly;
performing a porosity adjustment process that forms at least a portion in a vicinity of a periphery of the second porous body with a porosity lower than the second porosity;
laminating the second porous body on the first porous body laminated on the membrane electrode assembly;
injecting a seal member including at least one of a thermosetting resin and a thermoplastic resin on a periphery of the membrane electrode assembly on which the first porous body and the second porous body are laminated, to integrate the membrane electrode assembly, the second porous body and the seal member by injection molding.

2. The method according to claim 1, wherein the porosity adjustment process impregnates the at least the portion in the vicinity of the periphery of the second porous body with a predetermined material.

3. The method according to claim 1, wherein the porosity adjustment process makes the at least the portion in the vicinity of the periphery of the second porous body using a slurry formed with a less foaming agent, as compared with an other portion of the second porous body.

4. The method according to claim 1, wherein the porosity adjustment process shapes the second porous body to make the at least the portion in the vicinity of the periphery of the second porous body thicker than an other portion of the second porous body, and presses the at least the portion in the vicinity of the periphery of the second porous body to collapse a pore therein.

5. The method according to claim 1, wherein the second porous body is a porous channel in which a gas used for electric generation in a fuel cell flows in a predetermined direction, and the first porous body is a gas diffusion layer that diffuses the gas.

6. The method according to claim 1, wherein the first porous body is laminated on the membrane electrode assembly by joining the first porous body at both sides of the membrane electrode assembly.

7. A fuel cell component, comprising:
a membrane electrode assembly;
a gas diffusion layer that is laminated on the membrane electrode assembly, the gas diffusion layer having a first porosity;
a porous channel that is laminated on the gas diffusion layer, the porous channel having an interior portion with a second porosity that is higher than the first porosity and at least a portion in a vicinity of a periphery of the porous channel with a porosity lower than the second porosity; and
a seal member that is integrated with the membrane electrode assembly, the gas diffusion layer and the porous channel by injection molding.

8. (canceled)

9. A method of manufacturing a fuel cell component, comprising:
forming a porous body in which a porosity in at least a portion in a vicinity of a periphery of the porous body is lower than a porosity in an interior portion of the porous body; and
arranging a seal member on the periphery of the porous body to integrate the seal member with the porous body.

10. The method according to claim 9, wherein the portion in the vicinity of the periphery of the porous body is impregnated with a predetermined material.

11. The method according to claim 9, further comprising:
laminating the porous body outside a membrane electrode assembly before the injection-molding, wherein
the seal member is arranged on the periphery of the porous body to integrate the seal member with the porous body and the membrane electrode assembly.

12. The method according to claim 9, wherein the seal member is arranged on the periphery of the porous body by injection molding.

13. A porous body for a fuel cell configured to be integrated with a seal member arranged on a periphery of the porous body, the porous body comprising a portion in a vicinity of the periphery of the porous body with a porosity lower than a porosity in an interior portion of the porous body.

14. A fuel cell component, comprising:
a membrane electrode assembly;
the porous body according to claim 13, that is laminated outside the membrane electrode assembly; and
a seal member that is integrated with the membrane electrode assembly and the porous body.
